(19) United States
(12) Patent Application Publication
(10) Pub. No.: US 2013/0194082 A1
(43) Pub. Date: Aug. 1, 2013

(54) STATIC ANALYSIS OF AUDIO SIGNALS FOR GENERATION OF DISCERNABLE FEEDBACK

(71) Applicant: Ilya Polyakov, San Francisco, CA (US)

(72) Inventor: Ilya Polyakov, San Francisco, CA (US)

(73) Assignee: Bayer Intellectual Property GmbH, Monheim (DE)

(21) Appl. No.: 13/634,965

(22) PCT Filed: Mar. 17, 2011
(86) PCT No.: PCT/EP2011/054015

§ 371 Date: Dec. 3, 2012

Related U.S. Application Data
(60) Provisional application No. 61/314,941, filed on Mar. 17, 2010.
(60) Provisional application No. 61/402,139, filed on Aug. 24, 2010.

(51) Int. Cl. G06F 3/01

(52) U.S. Cl. CPC G06F 3/01
USPC 340/384.5

(57) ABSTRACT

Electroactive transducers as well as methods of producing a haptic effect in a user interface device simultaneously with a sound generated by a separately generated audio signal and electroactive polymer transducers for sensory feedback applications in user interface devices are disclosed.

### RELATED APPLICATIONS

The present invention is a non-provisional application of provisional applications 61/314,941 filed Mar. 17, 2010 and 61/402,139 filed Aug. 24, 2010, the entireties of which are incorporated by reference herein.

### FIELD OF THE INVENTION

The present invention is directed to using an analysis of an existing audio signal to improve a discernable effect in an electronic device where the discernable effect is intended to provide sensory feedback (such as haptic or other sensory feedback).

### BACKGROUND

A tremendous variety of devices used today rely on actuators of one sort or another to convert electrical energy to mechanical energy. Conversely, many power generation applications operate by converting mechanical action into electrical energy. Employed to harvest mechanical energy in this fashion, the same type of actuator may be referred to as a generator. Likewise, when the structure is employed to convert physical stimulus such as vibration or pressure into an electrical signal for measurement purposes, it may be characterized as a sensor. Yet, the term “transducer” may be used to generically refer to any of the devices.

A number of design considerations favor the selection and use of advanced dielectric elastomer materials, also referred to as “electroactive polymers” (EAPs), for the fabrication of transducers. These considerations include potential force, power density, power conversion/consumption, size, weight, cost, response time, duty cycle, service requirements, environmental impact, etc. As such, in many applications, EAP technology offers an ideal replacement for piezoelectric, shape-memory alloy (SMA) and electromagnetic devices such as motors and solenoids. Examples of EAP devices and their applications are described, for example, in U.S. Pat. Nos. 7,394,282; 7,378,783; 7,368,862; 7,362,032; 7,320,457; 7,259,503; 7,233,097; 7,224,106; 7,211,937; 7,199,501; 7,166,953; 7,064,472; 7,062,055; 7,052,594; 7,049,732; 7,034,432; 6,940,221; 6,911,764; 6,891,317; 6,882,086; 6,876,135; 6,812,624; 6,809,462; 6,806,621; 6,781,284; 6,768,246; 6,707,236; 6,664,718; 6,628,040; 6,586,859; 6,583,533; 6,545,384; 6,543,110; 6,376,971 and 6,343,129; and in U.S. Published Patent Application Nos. 2009/0001855; 2009/0154053; 2008/0180875; 2008/0157631; 2008/0116764; 2008/0022517; 2007/0230222; 2007/0200468; 2007/0200467; 2007/0200466; 2007/0200457; 2007/0200454; 2007/0200453; 2007/0170822; 2006/0238079; 2006/0208610; 2006/0208609; and 2005/0157893, and 2010/0109486; PCT application Nos. PCT/US09/63307; and PCT/US2011/000196; and PCT Publication No. WO 2009/067708.

An EAP transducer comprises two electrodes having deformable characteristics and separated by a thin elastomeric dielectric material. When a voltage difference is applied to the electrodes, the oppositely-charged electrodes attract each other thereby compressing the polymer dielectric layer therebetween. As the electrodes are pulled closer together, the dielectric polymer film becomes thinner (the z-axis component contracts) as it expands in the planar directions (along the x- and y-axes), i.e., the displacement of the film is in-plane. The EAP film may also be configured to produce movement in a direction orthogonal to the film structure (along the z-axis), i.e., the displacement of the film is out-of-plane. U.S. Published Patent Application No. 2005/0157893 discloses EAP film constructs which provide such out-of-plane displacement—also referred to as surface deformation or thickness mode deflection.

Numerous transducer-based applications exist which would benefit from the advantages provided by such EAP films. One such application includes the use of EAP films to produce haptic feedback (the communication of information to a user through forces applied to the user's body) in user interface devices. There are many known user interface devices which employ haptic feedback, typically in response to a force initiated by the user. Examples of user interface devices that may employ haptic feedback include keyboards, keypads, game controller, remote control, touch screens, computer mice, trackballs, stylus sticks, joysticks, etc. The user interface surface can comprise any surface that a user manipulates, engages, and/or observes regarding feedback or information from the device. Examples of such interface surfaces include, but are not limited to, a key (e.g., keys on a keyboard), a game pad or buttons, a display screen, etc.

The haptic feedback provided by these types of interface devices is in the form of physical sensations, such as vibrations, pulses, spring forces, etc., which a user senses either directly (e.g., via touching of the screen), indirectly (e.g., via a vibrational effect such a when a cell phone vibrates in a purse or bag) or otherwise sensed (e.g., via an action of a moving body that creates a pressure disturbance but does not generate an audio signal in the traditional sense).

Haptic feedback capabilities are known to improve user productivity and efficiency, particularly in the context of data entry. It is believed by the inventors hereof that further improvements to the character and quality of the haptic sensation communicated to a user may further increase such productivity and efficiency. It would be additionally beneficial if such improvements were provided by a sensory feedback mechanism which is easy and cost-effective to manufacture, and does not add to, and preferably reduces, the space, size and/or mass requirements of known haptic feedback devices.

However, there remains a need for improved control of haptic or other discernable feedback, including audio feedback of actuators or transducers using an existing audio source such as any gaming device or a media player. Current haptic solutions require either host software on the device to trigger the haptic effect though a dedicated channel or simply consist of filtering the audio in to the haptic transducer. The methods and procedures provided herein allow for improved control of discernable feedback (whether haptic or other) using an audio signal produced by an electronic device. Moreover, the methods and procedures for improved control of discernable feedback is useful in devices employing electroactive polymer transducers as well as other types transducers (e.g., piezoelectric) or vibratory motor.

### SUMMARY OF THE INVENTION

The present invention includes devices, systems and methods involving control of transducers for sensory applications whether haptic, audio or other feedback. In one variation, a user interface device having sensory feedback is provided. One benefit of the present invention is to provide the user of a user interface device with haptic feedback or other discernable feedback using an audio signal from the device.

In another variation, the present invention includes methods and procedures for improved control of a haptic actuator with signals originally triggered by, or extracted from an audio source such as any gaming device or a media player. Current haptic solutions require either host software on the device to trigger the haptic effect though a dedicated channel or simply consist of filtering the audio in to the haptic transducer. A variation of an improved method allows for an off-board haptic effect processor to determine the type of application being used on the host device either purely based on a statistical analysis of the audio or use of the statistical analysis to in conjunction with such current haptic solutions. Based on the type of application, the effect processor can analyze the audio signal to see if the audio should pass though a low-pass filter to act as a subwoofer (in the case of music), if the audio should pass though at a reduced volume with artificially synthesized effect waveforms super-imposed (games with background audio), or if the audio signal triggers a threshold based synthesized wave trigger. The same statistical engine can also determine the optimal incoming audio signal amplitude to trigger synthesized waveforms. Optionally an onboard digital signal processor (DSP) can determine the type of waveform to synthesize based on the audio—for example by varying frequency and amplitude to accentuate the audio.

Although the methods and procedures described herein can be used to improve upon response produced by an EAP-based transducers system, the methods are not limited to EAP based transducer systems. Any transducer or feedback based system can be improved using the methods and procedures described herein. For example, the control methods described herein can be equally applicable to piezoelectric transducers or other vibratory motors as well.

Methods and procedures described herein allow for selectively producing a discernable effect in an electronic device that produces an audio output signal. The discernable effect can be a haptic effect or any other type of sensory feedback effect. In one variation, the method includes the method involving: conditioning the audio sound signal using an analog circuit to generate an analog voltage corresponding to the audio sound signal; converting the analog voltage to a digital value and recording the digital value over a period of time to build an array of recorded digital values; analyzing at least a plurality of the recorded digital values to generate at least one control value; selecting a triggering mode using the at least one control value, where the triggering mode is selected from a plurality of modes including a first and a second mode; generating a triggering signal based on the triggering mode, where the triggering signal is unique to the triggering mode selected from the plurality of modes; and providing the triggering signal to a transducer that is coupled to the electronic device and is configured to generate the discernable effect.

In another variation of the inventive method, analyzing at least the plurality of the recorded digital values to generate at least one control value involves performing a statistical analysis on at least the plurality of recorded digital values. The statistical analysis can include calculating a mean, a standard deviation, and/or range of at least a plurality of the recorded digital values.

The triggering mode can be selected using number of criteria as a result of the statistical analysis. In one example, the triggering mode based on the range divided by the standard deviation.

In an additional variation, the method includes analyzing at least the plurality of the recorded digital values to generate at least one control value comprises analyzing a most recent digital value with the plurality of recorded digital values.

The triggering signal can be used to trigger the discernable effect by actuating the transducer. In such cases, providing the triggering signal involves converting at least one digital value to an analog voltage where the voltage can be applied to the transducer to actuate the transducer. In doing so, the triggering signal is generated based on a particular mode that is determined from analyzing the data. The modes can range from a pure trigger mode such that the triggering signal is selected from at least one stored waveform. The stored waveform can produce a pre-determined effect such as a key-click or similar effect. Alternatively, the mode can involve a mixed trigger mode such that the triggering signal is selected based on a first component selected from at least one stored waveform and a second component based on at least one digital value. As described below, the second component can be scaled down (e.g., to provide a lower background volume). Yet another mode can include a pure audio mode such that the triggering signal is selected using at least one digital value.

Another variation of the method includes selectively varying output in a transducer that is coupled to an electronic device, where the electronic device produces an audio output signal. In one example such a method involves conditioning the audio output sound signal to generate an analog voltage corresponding to the audio sound signal; converting the analog voltage to a digital value; analyzing at least a plurality of recorded digital values from an array of recorded digital values to generate at least one control value; selecting a triggering mode using the at least one control value, where the triggering mode is selected from a plurality of modes including a first and a second mode; generating a triggering signal based on the triggering mode, where the triggering signal is unique to the triggering mode selected from the plurality of modes; providing the triggering signal to a transducer that is coupled to the electronic device and is configured to generate the discernable effect.

The present invention can also include a method of triggering a transducer in an electronic device that produces an audio output signal. One variation includes conditioning the audio sound signal using an analog circuit to generate a digital value corresponding the audio sound signal; selecting a triggering mode by comparing the digital value to at least one recorded data value selected from an array of recorded data, where the triggering mode is selected from a plurality of modes; and triggering the transducer using the triggering signal, where the triggering signal is unique to at least one of the plurality of modes.

These and other features, objects and advantages of the invention will become apparent to those persons skilled in the art upon reading the details of the invention as more fully described below.

The electroactive polymer cartridges useful with these designs include, but are not limited to Planar, Diaphragm, Thickness Mode, and Passive Coupled devices (Hybrids).

The present invention may be employed in any type of user interface device including, but not limited to, touch pads, touch screens or key pads or the like for computer, phone, PDA, video game console, GPS system, kiosk applications, etc. However, the methods and procedures described herein to generate discernable feedback can be applied in any device and/or method analysis of an audio signal can assist in producing a discernable effect in a device.

As for other details of the present invention, materials and alternate related configurations may be employed as within the level of those with skill in the relevant art. The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

These and other features, objects and advantages of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying drawings. To facilitate understanding, the same reference numerals have been used (where practical) to designate similar elements that are common to the drawings. Included in the drawings are the following:

FIGS. 1A and 1B illustrate some examples of a user interface that can employ haptic feedback when an EAP transducer is coupled to a display screen or sensor and a body of the device.

FIGS. 2A and 2B illustrate a top perspective view of a transducer before and after application of a voltage in accordance with one embodiment of the present invention.

FIG. 3A illustrates a process of conditioning an audio signal by an analog circuit to adjust voltage levels and frequency range for the analog to digital converter of the haptic controller.

FIGS. 4A to 41 illustrate various waveform sample plots with an accompanying value dataset using the process shown in FIG. 3A.

Variation of the invention from that shown in the figures is contemplated.

### DETAILED DESCRIPTION OF THE INVENTION

The devices, systems and methods of the present invention are now described in detail with reference to the accompanying figures.

Examples of EAP devices and their applications are described in U.S. Pat. Nos. 7,394,282; 7,378,783; 7,368,862; 7,362,032; 7,320,457; 7,259,503; 7,233,097; 7,224,106; 7,211,937; 7,199,501; 7,166,953; 7,064,472; 7,062,055; 7,052,594; 7,049,732; 7,034,432; 6,940,221; 6,911,764; 6,891,317; 6,882,086; 6,876,135; 6,812,624; 6,809,462; 6,806,621; 6,781,284; 6,768,246; 6,707,236; 6,664,718; 6,628,040; 6,586,859; 6,583,533; 6,545,384; 6,543,110; 6,376,971 and 6,343,129; and in U.S. Published Patent Application Nos. 2009/0001855; 2009/0154053; 2008/0180875; 2008/0157631; 2008/0116764; 2008/0022517; 2007/0230222; 2007/0200468; 2007/0200467; 2007/0200466; 2007/0200457; 2007/0200454; 2007/0200453; 2007/0170822; 2006/0238079; 2006/0208610; 2006/0208609; and 2005/0157893, and 2010/0109486; PCT application Nos. PCT/US09/63307; and PCT/US201/000196; and PCT Publication No. WO 2009/067708, the entireties of which are incorporated herein by reference.

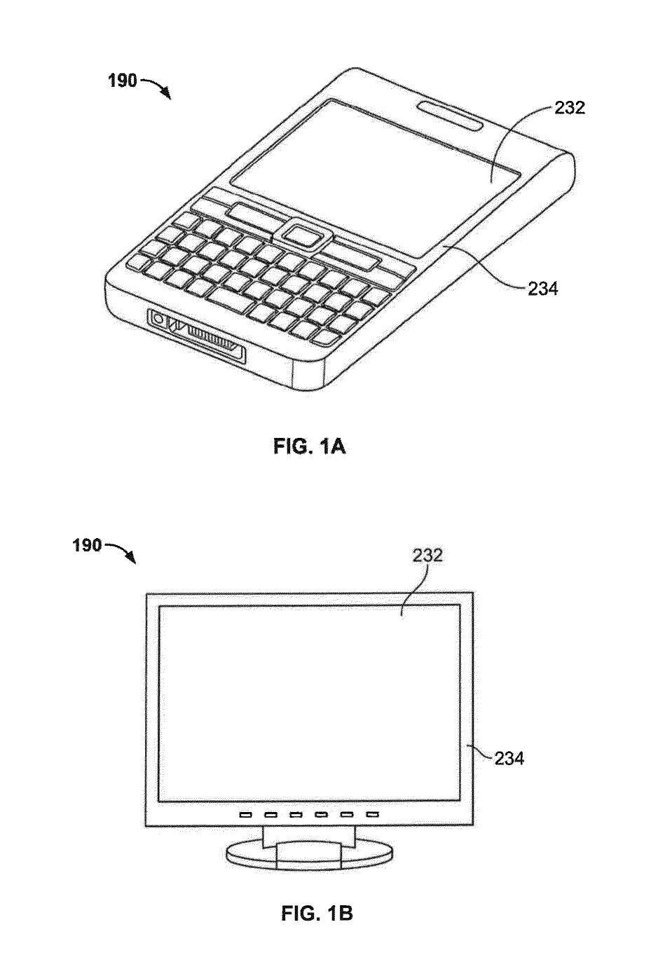

As noted above, devices requiring a user interface can be improved by the use of haptic feedback on the user screen of the device. FIGS. 1A and 1B illustrate simple examples of such devices 190. Each device includes a display screen 232 for which the user enters or views data. The display screen is coupled to a body or frame 234 of the device. Clearly, any number of devices are included within the scope of this disclosure regardless of whether portable (e.g., cell phones, computers, manufacturing equipment, etc.) or affixed to other non-portable structures (e.g., the screen of an information display panel, automatic teller screens, etc.) For purposes of this disclosure, a display screen can also include a touchpad type device where user input or interaction takes place on a monitor or location away from the actual touchpad (e.g., a lap-top computer touchpad). In addition, the control methods described herein can be applied in those devices employing a housing assembly that are removably coupled to an electronic media device. In such a case, the improved controls and potentially the transducer are separate but coupleable to the electronic device. An example of such devices can be found in PCT/US2011/000196

A number of design considerations favor the selection and use of advanced dielectric elastomer materials, also referred to as “electroactive polymers” (EAPs), for the fabrication of transducers especially when haptic feedback of the display screen 232 is sought. These considerations include potential force, power density, power conversion/consumption, size, weight, cost, response time, duty cycle, service requirements, environmental impact, etc. As such, in many applications, EAP technology offers an ideal replacement for piezoelectric, shape-memory alloy (SMA) and electromagnetic devices such as motors and solenoids.

An EAP transducer contains two thin film electrodes having elastic characteristics and separated by a thin elastomeric dielectric material. In some variations, the EAP transducer can include a non-elastic dielectric material. In any case, when a voltage difference is applied to the electrodes, the oppositely-charged electrodes attract each other thereby compressing the polymer dielectric layer therebetween. As the electrodes are pulled closer together, the dielectric polymer film becomes thinner (the z-axis component contracts) as it expands in the planar directions (the x- and y-axes components expand). The EAP transducer may be configured to displace to an applied voltage, which facilitates programming of a control system used with the subject tactile feedback devices. For example, a software algorithm may convert pixel grayscale to EAP transducer displacement, whereby the pixel grayscale value under the tip of the screen cursor is continuously measured and translated into a proportional displacement by the EAP transducer. By moving a finger across the touchpad, one could feel or sense a rough three-dimensional texture. A similar algorithm may be applied on a web page, where the border of an icon is fed back to the user as a bump in the page texture or a buzzing button upon moving a finger over the icon. To a normal user, this would provide an entirely new sensory experience while surfing the web, to the visually impaired this would add indispensable feedback.

EAP transducers are ideal for such applications for a number of reasons. For example, because of their light weight and minimal components, EAP transducers offer a very low profile and, as such, are ideal for use in sensory/haptic feedback applications.

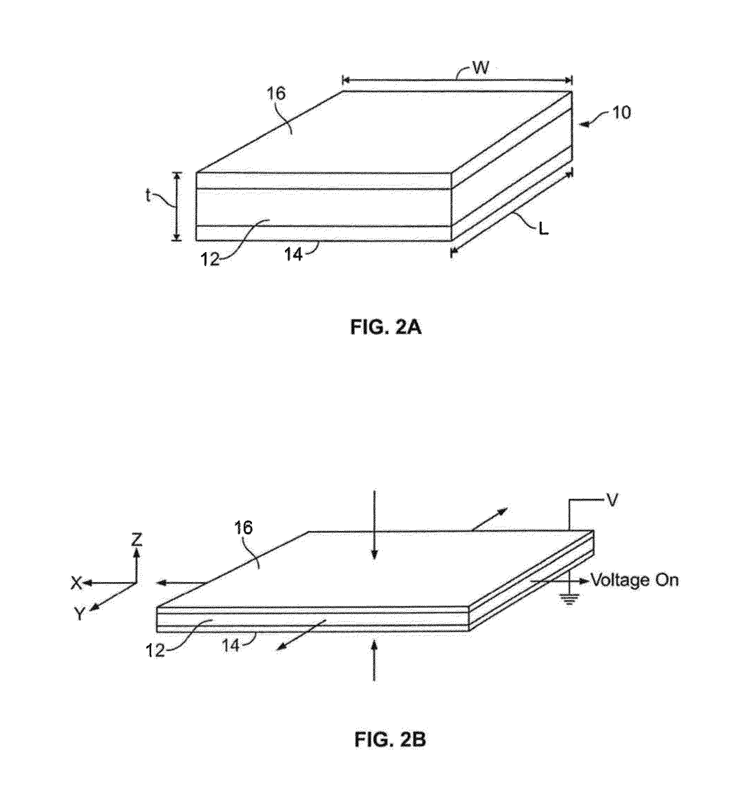

FIGS. 2A and 2B illustrate an example of an EAP film or membrane 10 structure. A thin elastomeric dielectric film or layer 12 is sandwiched between compliant or stretchable electrode plates or layers 14 and 16, thereby forming a capacitive structure or film. The length “l” and width “w” of the dielectric layer, as well as that of the composite structure, are much greater than its thickness “t”. Typically, the dielectric layer has a thickness in range from about 10 μm to about 100 μm, with the total thickness of the structure in the range from about 15 μm to about 10 cm. Additionally, it is desirable to select the elastic modulus, thickness, and/or the microgeometry of electrodes 14, 16 such that the additional stiffness they contribute to the actuator is generally less than the stiffness of the dielectric layer 12, which has a relatively low modulus of elasticity, i.e., less than about 100 MPa and more typically less than about 10 MPa, but is likely thicker than each of the electrodes. Electrodes suitable for use with these compliant capacitive structures are those capable of withstanding cyclic strains greater than about 1% without failure due to mechanical fatigue.

As seen in FIG. 2B, when a voltage is applied across the electrodes, the unlike charges in the two electrodes 14, 16 are attracted to each other and these electrostatic attractive forces compress the dielectric film 12 (along the z-axis). The dielectric film 12 is thereby caused to deflect with a change in electric field. As electrodes 14, 16 are compliant, they change shape with dielectric layer 12. Generally speaking, deflection refers to any displacement, expansion, contraction, torsion, linear or area strain, or any other deformation of a portion of dielectric film 12. Depending on the architecture, e.g., a frame, in which capacitive structure 10 is employed (collectively referred to as a “transducer”), this deflection may be used to produce mechanical work. Various different transducer architectures are disclosed and described in the above-identified patent references.

With a voltage applied, the transducer film 10 continues to deflect until mechanical forces balance the electrostatic forces driving the deflection. The mechanical forces include elastic restoring forces of the dielectric layer 12, the compliance or stretching of the electrodes 14, 16 and any external resistance provided by a device and/or load coupled to transducer 10. The resultant deflection of the transducer 10 as a result of the applied voltage may also depend on a number of other factors such as the dielectric constant of the elastomeric material and its size and stiffness. Removal of the voltage difference and the induced charge causes the reverse effects.

In some cases, the electrodes 14 and 16 may cover a limited portion of dielectric film 12 relative to the total area of the film. This may be done to prevent electrical breakdown around the edge of the dielectric or achieve customized deflections in certain portions thereof. Dielectric material outside an active area (the latter being a portion of the dielectric material having sufficient electrostatic force to enable deflection of that portion) may be caused to act as an external spring force on the active area during deflection. More specifically, material outside the active area may resist or enhance active area deflection by its contraction or expansion.

The dielectric film 12 may be pre-strained. The pre-strain improves conversion between electrical and mechanical energy, i.e., the pre-strain allows the dielectric film 12 to deflect more and provide greater mechanical work. Pre-strain of a film may be described as the change in dimension in a direction after pre-straining relative to the dimension in that direction before pre-straining. The pre-strain may comprise elastic deformation of the dielectric film and be formed, for example, by stretching the film in tension and fixing one or more of the edges while stretched. The pre-strain may be imposed at the boundaries of the film or for only a portion of the film and may be implemented by using a rigid frame or by stiffening a portion of the film.

The transducer structure of FIGS. 2A and 2B and other similar compliant structures and the details of their constructs are more fully described in many of the referenced patents and publications disclosed herein.

Performance may be enhanced by prestraining the dielectric film and/or the passive material. The actuator may be used as a key or button device and may be stacked or integrated with sensor devices such as membrane switches. The bottom output member or bottom electrode can be used to provide sufficient pressure to a membrane switch to complete the circuit or can complete the circuit directly if the bottom output member has a conductive layer. Multiple actuators can be used in arrays for applications such as keypads or keyboards.

The various dielectric elastomer and electrode materials disclosed in U.S. Published Patent Application No. 2005/0157893 are suitable for use with the thickness mode transducers of the present invention. Generally, the dielectric elastomers include any substantially insulating, compliant polymer, such as silicone rubber and acrylic, that deforms in response to an electrostatic force or whose deformation results in a change in electric field. In designing or choosing an appropriate polymer, one may consider the optimal material, physical, and chemical properties. Such properties can be tailored by judicious selection of monomer (including any side chains), additives, degree of cross-linking, crystallinity, molecular weight, etc.

Electrodes described therein and suitable for use include structured electrodes comprising metal traces and charge distribution layers, textured electrodes, conductive greases such as carbon greases or silver greases, colloidal suspensions, high aspect ratio conductive materials such as conductive carbon black, carbon fibrils, carbon nanotubes, graphene and metal nanowires, and mixtures of ionically conductive materials. The electrodes may be made of a compliant material such as elastomer matrix containing carbon or other conductive particles. The present invention may also employ metal and semi-inflexible electrodes. Exemplary passive layer materials for use in the subject transducers include but are not limited to silicone, styrenic or olefinic copolymer, polyurethane, acrylate, rubber, a soft polymer, a soft elastomer (gel), soft polymer foam, or a polymer/gel hybrid, for example. The relative elasticity and thickness of the passive layer(s) and dielectric layer are selected to achieve a desired output (e.g., the net thickness or thinness of the intended surface features), where that output response may be designed to be linear (e.g., the passive layer thickness is amplified proportionally to the that of the dielectric layer when activated) or non-linear (e.g., the passive and dielectric layers get thinner or thicker at varying rates).

Regarding methodology, the subject methods may include each of the mechanical and/or activities associated with use of the devices described. As such, methodology implicit to the use of the devices described forms part of the invention. Other methods may focus on fabrication of such devices.

As for other details of the present invention, materials and alternate related configurations may be employed as within the level of those with skill in the relevant art. The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

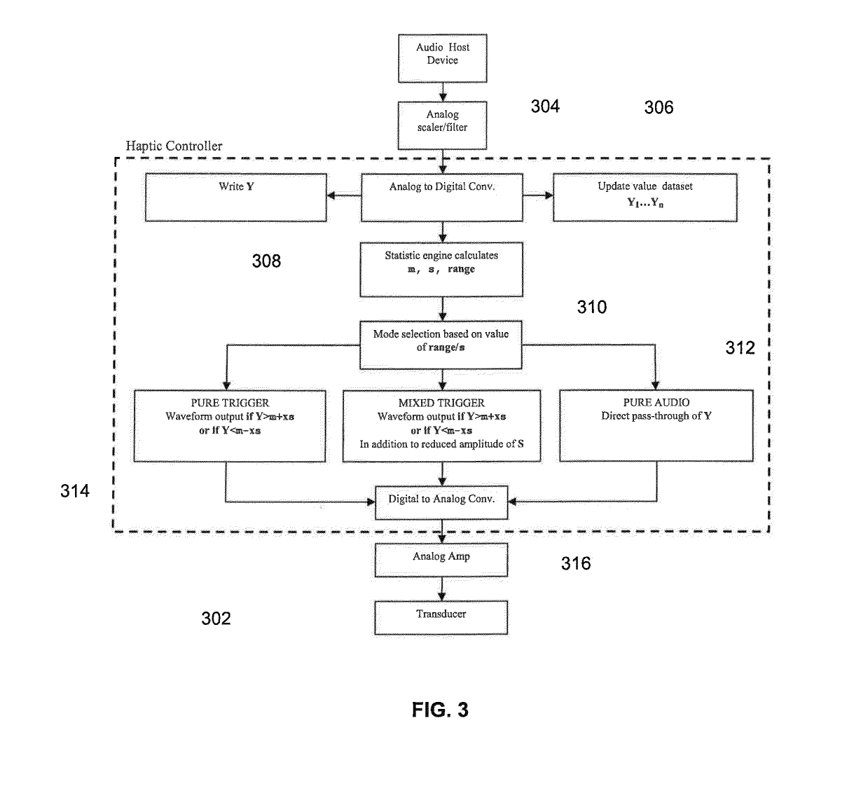

Another method and procedure for improving control of a haptic actuator includes the use of statistical analysis of audio signals to generate an improved haptic effect. Such a process includes conditioning an audio signal by an analog circuit to adjust voltage levels and frequency range for the analog to digital converter of the haptic controller. An example of which is shown in FIG. 3. The haptic controller 302 can be any embedded system which matches the memory, port and speed requirements of the control algorithm. The incoming analog voltage is converted to a digital value (var Y) 304. This value is also added to an array containing n amount of previous Y values to comprise a running, constantly updated statistical dataset 306. The size of the dataset can be optimized to maximize system adaptability to signal variation but is ultimately dependent on the resolution of the value of Y and the available memory. With every incoming Y, the standard deviation, mean and range of the dataset is computed and updated 308. Optionally, the kurtosis could be computed as well. However, doing so results in an intensive and overly precise indicator, dividing the range by the standard deviation can yield a sufficient indicator of the shape of the histogram of the collected Y samples.

The shape of the histogram is dependent on the type of audio signal. Noisy music produces a wide, “full” curve with the lowest value of range/S 310. During this condition Y can be passed directly to the digital to analog converter making the transducer act as a “subwoofer” 312. Situations where sharp clicks or peaks are dispersed among low noise or silence result in a very sharp histogram and the highest value of range/S. The clicks and peaks may be too short to produce a desirable haptic event but can be used to trigger a stored waveform 314. Experimental data shows that triggering a stored wave when the value of the incoming signal is below or above xS from m 316. The exact value of x is determined experimentally. Previously a value of x=2 was found acceptable. At this point the exact waveform shape can be determined by more advanced processing of the signal to determine best amplitude and frequency of the outgoing wave. Games which contain both background music and game effects typically have the effects at a louder volume or have the means to adjust the two volumes independently. The resulting histogram is somewhere between the noisy music and bare click. While numerous options exist, the most straight forward option is to mix the music, possibly at a much reduced volume with the triggered waveform. This would still have a subtle “subwoofer” effect while having strong, prominent special effects. The extent to which the music is silenced and the triggered waves are accentuated can be proportionally adjusted with the ratio range/s.

This system, as well as variations of the system, are advantageous as they opens the possibility of high fidelity haptics previously unavailable due to software architecture limitations. Many gaming devices and games do not incorporate a haptic data channel, current solution involves waveform triggering from sound amplitude threshold which is manually and permanently set, variation in games and system audio volume produces an inconsistent experience and may not work at all.

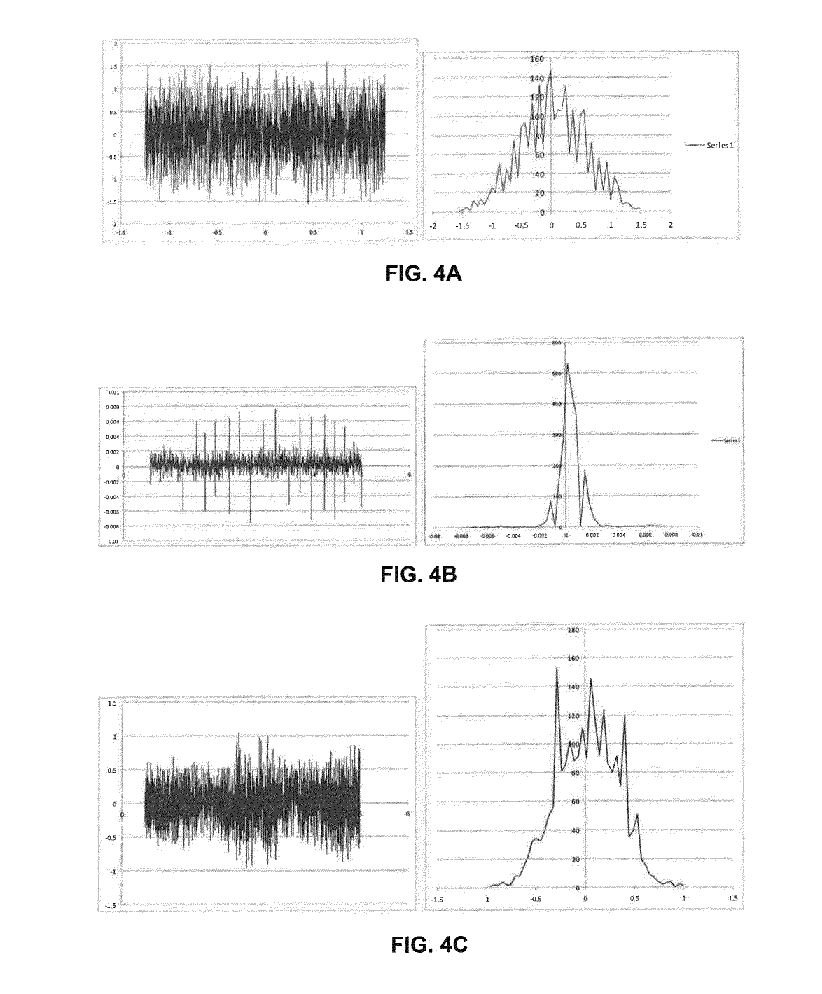

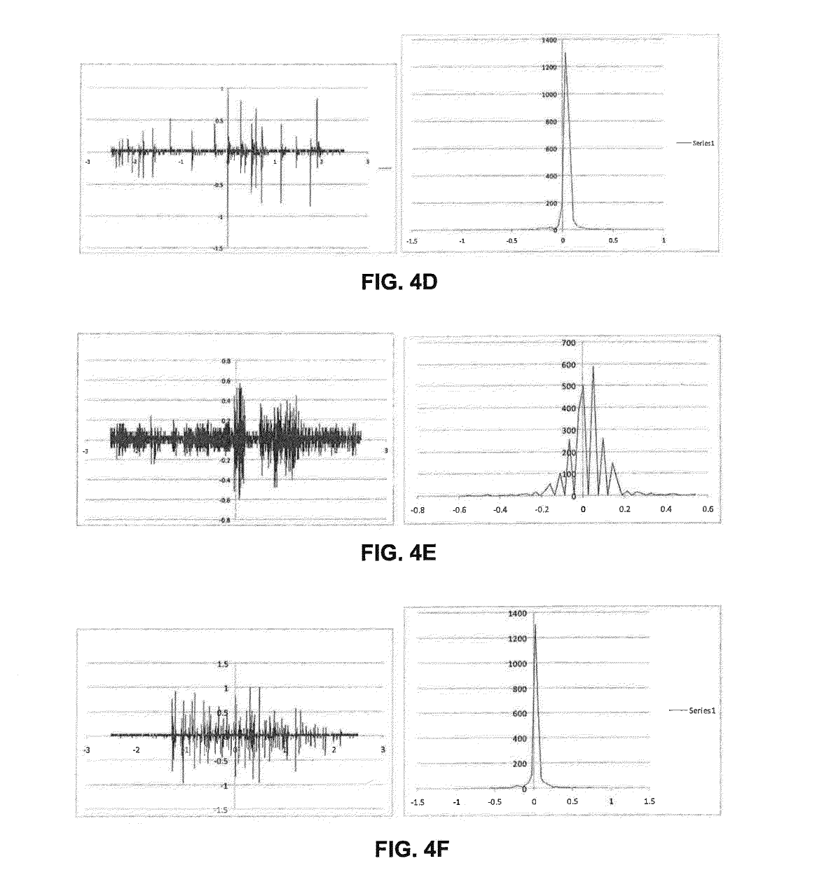

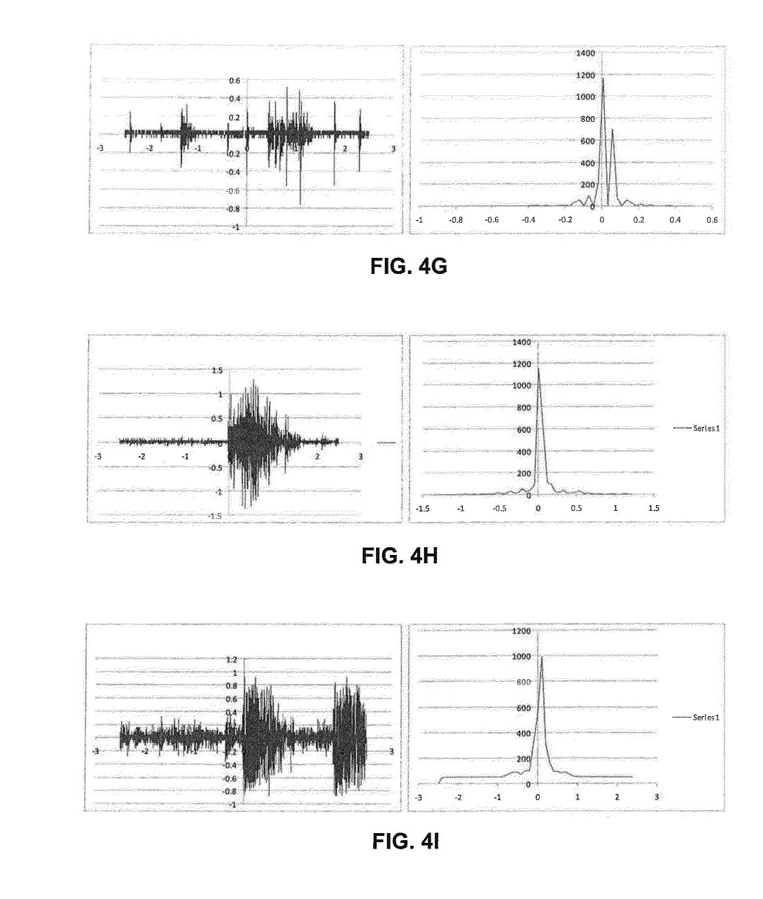

FIGS. 4A to 41 illustrate various waveform sample plots with an accompanying value dataset. FIG. 4A illustrates a waveform sample plot with an accompanying value dataset of music. FIG. 4B illustrates a waveform sample plot with an accompanying value dataset of native key clicks. FIG. 4C illustrates a waveform sample plot with an accompanying value dataset of a video game (NEED FOR SPEED) with sound data from the game plus background music. FIG. 4D illustrates a waveform sample plot with an accompanying value dataset of a video game (AIR HOCKEY) with sound data from the game. FIG. 4E illustrates a waveform sample plot with an accompanying value dataset of a video game (FREEBALLIN PINBALL) with sound data from the game. FIG. 4F illustrates a waveform sample plot with an accompanying value dataset of a video game (VIRTUAL DICE) with sound data from the game. FIG. 4G illustrates a waveform sample plot with an accompanying value dataset of a video game (LABYRINTH) with sound data from the game. FIG. 4H illustrates a waveform sample plot with an accompanying value dataset of a video game (CUBERUNNER) with music from the game as well as sound data from the game. FIG. 4I illustrates a waveform sample plot with an accompanying value dataset of a video game (CUBE FPS) with sound data from the game as well as background music.

As for other details of the present invention, materials and alternate related configurations may be employed as within the level of those with skill in the relevant art. The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth n the claims. Stated otherwise, unless specifically defined herein, all technical and scientific terms used herein are to be given as broad a commonly understood meaning as possible while maintaining claim validity.

What is claimed is:

1. A method of selectively producing a discernable effect in an electronic device that produces an audio output signal, the method comprising:
conditioning the audio sound signal using an analog circuit to generate an analog voltage corresponding to the audio sound signal;
converting the analog voltage to a digital value and recording the digital value over a period of time to build an array of recorded digital values;
analyzing at least a plurality of the recorded digital values to generate at least one control value;
selecting a triggering mode using the at least one control value, where the triggering mode is selected from a plurality of modes including a first and a second mode;
generating a triggering signal based on the triggering mode, where the triggering signal is unique to the triggering mode selected from the plurality of modes;
providing the triggering signal to a transducer that is coupled to the electronic device and is configured to generate the discernable effect.

2. The method according to claim 1, wherein analyzing at least the plurality of the recorded digital values to generate at least one control value comprises performing a statistical analysis on at least the plurality of recorded digital values.

3. The method according to claim 2, wherein the statistical analysis comprises calculating a mean, a standard deviation, and/or range of at least a plurality of the recorded digital values.

4. The method according to claim 3, wherein selecting the triggering mode comprises selecting the triggering mode based on the range divided by the standard deviation.

5. The method according to claim 1, wherein analyzing at least the plurality of the recorded digital values to generate at least one control value comprises analyzing a most recent digital value with the plurality of recorded digital values.

6. The method according to claim 1, wherein providing the triggering signal comprises converting at least one digital value to an analog voltage.

7. The method according to claim 1, wherein at least one of the plurality of modes comprises a pure trigger mode such that the triggering signal is selected from at least one stored waveform.

8. The method according to claim 1, wherein at least one of the plurality of modes comprises a mixed trigger mode such that the triggering signal is selected based on a first component selected from at least one stored waveform and a second component based on at least one digital value.

9. The method according to claim 1, wherein at least one of the plurality of modes comprises a pure audio mode such that the triggering signal is selected using at least one digital value.

10. The method according to claim 1, wherein the transducers comprises a transducer selected from an electroactive polymer transducer and a piezoelectric transducer.

11. A method of selectively varying output in a transducer that is coupled to an electronic device, where the electronic device produces an audio output signal, the method comprising:
conditioning the audio output sound signal to generate an analog voltage corresponding to the audio sound signal;
converting the analog voltage to a digital value;
analyzing at least a plurality of recorded digital values from an array of recorded digital values to generate at least one control value;
selecting a triggering mode using the at least one control value, where the triggering mode is selected from a plurality of modes including a first and a second mode;
generating a triggering signal based on the triggering mode, where the triggering signal is unique to the triggering mode selected from the plurality of modes; and
providing the triggering signal to a transducer that is coupled to the electronic device and is configured to generate the discernable effect.

12. The method according to claim 11, wherein analyzing at least the plurality of the recorded digital values to generate at least one control value comprises performing a statistical analysis on at least the plurality of recorded digital values.

13. The method according to claim 12, wherein the statistical analysis comprises calculating a mean, a standard deviation, and/or range of at least a plurality of the recorded digital values.

14. The method according to claim 13, wherein selecting the triggering mode comprises selecting the triggering mode based on the range divided by the standard deviation.

15. The method according to claim 11, wherein analyzing at least the plurality of the recorded digital values to generate at least one control value comprises analyzing a most recent digital value with the plurality of recorded digital values.

16. The method according to claim 11, wherein providing the triggering signal comprises converting at least one digital value to an analog voltage.

17. The method according to claim 11, wherein at least one of the plurality of modes comprises a pure trigger mode such that the triggering signal is selected from at least one stored waveform.

18. The method according to claim 11, wherein at least one of the plurality of modes comprises a mixed trigger mode such that the triggering signal is selected based on a first component selected from at least one stored waveform and a second component based on at least one digital value.

19. The method according to claim 11, wherein at least one of the plurality of modes comprises a pure audio mode such that the triggering signal is selected using at least one digital value.

20. The method according to claim 11, wherein a most recent digital value with the plurality of recorded digital values where at least one of the plurality of modes comprises a mixed trigger mode such that the triggering signal comprises a first component selected from at least one stored waveform and a second component based on at least one digital value.

21. The method according to claim 11, wherein the transducers comprises a transducer selected from an electroactive polymer transducer and a piezoelectric transducer.

22. A method of triggering a transducer in an electronic device that produces an audio output signal, the method comprising:
conditioning the audio sound signal using an analog circuit to generate a digital value corresponding the audio sound signal;
selecting a triggering mode by comparing the digital value to at least one recorded data value selected from an array of recorded data, where the triggering mode is selected from a plurality of modes; and
triggering the transducer using the triggering signal, where the triggering signal is unique to at least one of the plurality of modes.
